(19) United States
(12) Patent Application Publication
(10) Pub. No.: US 2012/0279617 A1
(43) Pub. Date: Nov. 8, 2012

(54) HIGH STRENGTH GALVANIZED STEEL SHEET HAVING EXCELLENT FATIGUE RESISTANCE AND STRETCH FLANGEABILITY AND METHOD FOR MANUFACTURING THE SAME

(75) Inventors: Yoshiyasu Kawasaki, Tokyo (JP); Tatsuya Nakagaito, Tokyo (JP); Shinjiro Kaneko, Tokyo (JP); Yasunobu Nagataki, Tokyo (JP)

(73) Assignee: JFE STEEL CORPORATION, Tokyo (JP)

(21) Appl. No.: 13/521,078

(22) PCT Filed: Jan. 18, 2011
(86) PCT No.: PCT/JP2011/051155

§ 371 Date: Jul. 9, 2012

(30) Foreign Application Priority Data
Jan. 22, 2010 (JP) 2010-011952
Nov. 25, 2010 (JP) 2010-262088

(51) Int. Cl. B32B 15/01; B05D 3/02

(52) U.S. Cl. 148/533; 148/400

(57) ABSTRACT

A steel sheet has the chemical composition containing, by mass %, C: 0.04 to 0.13%, Si: 0.9 to 2.3%, Mn: 0.8 to 1.8%, P: 0.1% or less, S: 0.01% or less, Al: 0.1% or less, N: 0.008% or less, the remainder being Fe and the inevitable impurities and a microstructure including, in terms of area ratio, a ferrite phase of 80% or more, a bainitic ferrite phase of 1.0% or more, a pearlite phase of 1.0 to 10.0%, and a martensite phase of 1.0% or more and less than 5.0%, wherein the mean grain size of ferrite is 14 μm or less, the mean grain size of martensite is 4 μm or less, the mean free path of martensite is 3 μm or more, the Vickers hardness of ferrite is 140 or more, and the relationship area ratio of martensite/(area ratio of bainitic ferrite+area ratio of pearlite) 0.6 is satisfied.

### RELATED APPLICATIONS

This is a §371 of International Application No. PCT/JP2011/051155, with an international filing date of Jan. 18, 2011 (WO 2011/090182 A2, published Jul. 28, 2011), which is based on Japanese Patent Application Nos. 2010-011952, filed Jan. 22, 2010, and 2010-262088, filed Nov. 25, 2010, the subject matter of which is incorporated by reference.

### TECHNICAL FIELD

This disclosure relates to a high strength galvanized steel sheet having excellent fatigue resistance and stretch flangeability suitable for use as a member in industries including the automotive industry and to a method for manufacturing the steel sheet.

### BACKGROUND

Recently, the improvement of the fuel efficiency of automobiles has become an important issue from the viewpoint of global environment conservation, which has been driving a trend toward reducing the thickness of materials for automobile bodies by strengthening the materials and to reduce the weight of the automobiles themselves. In addition, the demand for a steel sheet having not only high strength, but also excellent fatigue resistance is high because the life spans of these materials for automobile bodies depend on their fatigue resistance.

Furthermore, when a high strength steel sheet is formed into a complex shape such as a member of an automobile, the occurrence of fractures or necking at the stretch flange portion of the member is a significant problem. Therefore, a steel sheet having excellent stretch flangeability is demanded to solve the problem of fractures or necking occurring at the stretch flange portion.

Various high strength multi-phase steel sheets, including a ferrite-martensite dual-phase steel and a TRIP steel which makes use of transformation induced plasticity of retained austenite, have been developed to improve the formability of a high strength steel sheet.

For example, Japanese Unexamined Patent Application Publication No. 2007-182625 discloses a steel sheet having excellent ductility achieved by specifying the chemical composition and volume fractions of ferrite, bainitic ferrite, and retained austenite. Moreover, Japanese Unexamined Patent Application Publication No. 2005-298877 discloses a steel sheet having excellent fatigue crack propagation resistance achieved by specifying ferrite hardness and the area ratio, aspect ratio and mean spacing of martensite. Furthermore, Japanese Patent No. 3231204 discloses a steel sheet having excellent fatigue resistance achieved by specifying the grain size and the hardness of each phase of a three phase microstructure consisting of ferrite, bainite, and martensite.

However, stretch flangeability is not taken into account by JP '625, because its main object is to improve the ductility of a high strength steel sheet. Moreover, stretch flangeability is not taken into account by JP '877 or JP '204, because they seek to improve the fatigue resistance of a high strength steel sheet. Therefore, it is desirable to develop a high strength steel sheet, especially a high strength galvanized steel sheet having not only excellent fatigue resistance, but also excellent stretch flangeability.

It could therefore be helpful to provide a high strength galvanized steel sheet having not only high strength (tensile strength TS of 590 MPa or more), but also excellent fatigue resistance and stretch flangeability and a method for manufacturing the steel sheet.

### SUMMARY

We discovered the following facts:
The positive addition of Si makes it possible to attain solid-solution strengthening and good fatigue resistance for ferrite and to improve stretch flangeability by reducing the difference in hardness with the second phase. Moreover, utilizing a medium hardness phase such as bainitic ferrite and pearlite makes it possible to reduce the difference in hardness between soft ferrite and hard martensite, which results in improvement of stretch flangeability. Furthermore, in the case where there is a large amount of hard martensite in the final microstructure, stretch flangeability is reduced by the large difference in hardness at the interface with soft ferrite. Accordingly, a microstructure consisting of ferrite, bainitic ferrite, pearlite, and a small amount of martensite is built up by making pearlite from a part of untransformed austenite which is to transform into martensite finally, thereby attaining stretch flangeability as well as high strength. Moreover, fine dispersion of hard martensite allows high strength, stretch flangeability, and fatigue resistance to be attained simultaneously.

We thus provide:
[1] A high strength galvanized steel sheet having excellent fatigue resistance and stretch flangeability, the steel sheet having a chemical composition containing, by mass %, C: 0.04 to 0.13%, Si: 0.9 to 2.3%, Mn: 0.8 to 1.8%, P: 0.1% or less, S: 0.01% or less, Al: 0.1% or less, N: 0.008% or less, and the remainder being Fe and inevitable impurities and a microstructure including, in terms of area ratio, a ferrite phase of 80% or more, a bainitic ferrite phase of 1.0% or more, a pearlite phase of 1.0 to 10.0%, and a martensite phase of 1.0% or more and less than 5.0%, wherein the mean grain size of ferrite is 14 μm or less, the mean grain size of martensite is 4 μm or less, the mean free path of martensite is 3 μm or more, the Vickers hardness of ferrite is 140 or more, and the relationship area ratio of martensite/(area ratio of bainitic ferrite+area ratio of pearlite) 0.6 is satisfied.
[2] The high strength galvanized steel sheet having excellent fatigue resistance and stretch flangeability according to [1], wherein the chemical composition further contains, by mass %, at least one of chemical elements selected from Cr: 0.05 to 1.0%, V: 0.005 to 0.5%, Mo: 0.005 to 0.5%, Ni: 0.05 to 1.0%, and Cu: 0.05 to 1.0%.
[3] The high strength galvanized steel sheet having excellent fatigue resistance and stretch flangeability according to [1] or [2], wherein the chemical composition further contains, by mass %, at least one of chemical elements selected from Ti: 0.01 to 0.1%, Nb: 0.01 to 0.1%, and B: 0.0003 to 0.0050%.
[4] The high strength galvanized steel sheet having excellent fatigue resistance and stretch flangeability according to any one of [1] to [3], wherein the chemical composition further contains, by mass %, at least one of chemical elements selected from Ca: 0.001 to 0.005% and REM: 0.001 to 0.005%.
[5] The high strength galvanized steel sheet having excellent fatigue resistance and stretch flangeability according to any one of [1] to [4], wherein the chemical composition further contains, by mass %, at least one of chemical elements selected from Ta: 0.001 to 0.010% and Sn: 0.002 to 0.2%.
[6] The high strength galvanized steel sheet having excellent fatigue resistance and stretch flangeability according to any one of [1] to [5], wherein the chemical composition further contains, by mass %, Sb: 0.002 to 0.2%.
[7] A method for manufacturing a high strength galvanized steel sheet having excellent fatigue resistance and stretch flangeability, the method including: hot rolling and pickling a steel slab having the chemical composition according to any one of [1] to [6], optionally cold rolling the resulting steel sheet, then heating the steel sheet up to a temperature in a range of 700° C. or higher at a mean heating rate of 8° C./s or more, holding the steel sheet in a temperature range of 800 to 900° C. for 15 to 600 seconds, then after cooling the steel sheet, holding in a temperature range of 450 to 550° C. for 10 to 200 seconds, and then galvanizing the steel sheet.
[8] The method for manufacturing the high strength galvanized steel sheet having excellent fatigue resistance and stretch flangeability according to [7], further including conducting alloying treatment for a galvanized layer in a temperature range of 500 to 600° C. under conditions that satisfy the inequality: 0.45≦exp [200/(400−T)]×In(t) 1.0, where T denotes a mean holding temperature in units of ° C., t denotes a holding time in units of s, exp(X) denotes the exponential of X, and In(X) denotes the natural logarithm of X.

Note that, herein, the unit % denotes percent by mass in describing the chemical component of steel, and “a high strength galvanized steel sheet” means a galvanized steel sheet having a tensile strength TS of 590 MPa or more.

Moreover, herein, a steel sheet which is provided with a coated layer by using galvanizing method is generically referred to as a “galvanized steel sheet” whether or not the steel sheet undergoes alloying treatment. That is to say, our galvanized steel sheets include both a galvanized steel sheet manufactured without alloying treatment and a galvannealed steel sheet manufactured with alloying treatment.

Thus, a high strength galvanized steel sheet having not only high strength (tensile strength TS of 590 MPa or more), but also excellent fatigue resistance and stretch flangeability can be obtained. The industrial utility of using the high strength galvanized steel sheet is very large because, for example, fuel efficiency is expected to be improved by decreasing the weight of an automobile body, if the steel sheet is applied to structural members of an automobile.

### DETAILED DESCRIPTION

Details of our steel sheets and methods will be described below.

In general, it is known that, although ductility can be attained for the dual phase microstructure of soft ferrite and hard martensite, satisfactory stretch flangeability is not obtained because the difference in hardness between ferrite and martensite is large. We studied the use of medium hardness phases of bainitic ferrite and pearlite by focusing on improving fatigue resistance and stretch flangeability with high strength attained by controlling phase fractions (i.e., area ratios) and mean grain sizes and by controlling the dispersion state (i.e., mean free path) of martensite in a multi-phase microstructure consisting of ferrite, bainitic ferrite, pearlite and martensite.

As a result, we attained both excellent fatigue resistance with high strength and stretch flangeability simultaneously by positive addition of Si for solid-solution strengthening of ferrite, by building up a multi-phase microstructure consisting of ferrite, bainitic ferrite, pearlite and a small amount of martensite, reducing the difference in hardness between different phases, controlling phase fractions (i.e., area ratios) and mean grain sizes, and controlling the dispersion state (i.e., mean free path) of martensite.

The chemical composition of our steel sheets contains, by mass %, C: 0.04 to 0.13%, Si: 0.9 to 2.3%, Mn: 0.8 to 1.8%, P: 0.1% or less, S: 0.01% or less, Al: 0.1% or less, N: 0.008% or less, the remainder, Fe and the inevitable impurities and a microstructure includes, in terms of area ratio, a ferrite phase of 80% or more, a bainitic ferrite phase of 1.0% or more, a pearlite phase of 1.0 to 10.0%, and a martensite phase of 1.0% or more and less than 5.0%, in which the mean grain size of ferrite is 14 μm or less, the mean grain size of martensite is 4 μm or less, the mean free path of martensite is 3 μm or more, the Vickers hardness of ferrite is 140 or more, and the relationship area ratio of martensite/(area ratio of bainitic ferrite+area ratio of pearlite) 0.6 is satisfied.

1) First, the chemical composition will be described below.

### C: 0.04 to 0.13%

C is a chemical element that forms austenite and is indispensable for strengthening steel. It is difficult to attain the specified strength if the carbon content is less than 0.04%. On the other hand, excessive addition of more than 0.13% of C causes a marked increase in the area ratio of martensite, which results in a decrease in stretch flangeability. Therefore, C content is 0.04 to 0.13%.

### Si: 0.9 to 2.3%

Si is a chemical element that forms ferrite and effective for solid-solution strengthening. Si content of 0.9% or more is necessary to improve the balance of strength and ductility and attaining a desired strength for the ferrite matrix. However, excessive addition of Si causes a decrease in surface quality due to generation of red scale and so forth, and a decrease in coating wettability and in coating adhesion. Therefore, Si content is 0.9 to 2.3%, preferably 1.2 to 1.8%.

### Mn: 0.8 to 1.8%

Mn is a chemical element that is effective to strengthen steel. Moreover, Mn is a chemical element necessary to adjust the fraction constituted by the second phase because Mn is a chemical element that stabilizes austenite. Therefore, Mn content of 0.8% or more is necessary. On the other hand, excessive addition of more than 1.8% of Mn causes an increase in the area ratio of martensite in the second phase, which results in difficulty in ensuring good stretch flangeability, and which results in an increase in cost due to the recent steep price rise of Mn. Therefore, Mn content is 0.8 to 1.8%, preferably 1.0 to 1.6%.

P: 0.1% or less

P is a chemical element that is effective to strengthen steel, but excessive addition of more than 0.1% of P causes embrittlement due to grain boundary segregation, a decrease in crashworthiness, and a significant decrease in alloying rate. Therefore, P content is 0.1% or less.

S: 0.01% or less

Although it is preferable that S content be as small as possible because S forms inclusions including MnS, which results in a decrease in crashworthiness and cracks forming in the direction of metal flow at a weld, S content is 0.01% or less from the viewpoint of cost.

Al: 0.1% or less

Al is a chemical element that forms ferrite and is effective to control the amount of ferrite formed during the manufacture of steel. However, excessive addition of Al causes a decrease in the quality of slabs during steel making. Therefore, Al content is 0.1% or less.

N: 0.008% or less

It is preferable that N content be as small as possible because N is a chemical element that most largely decreases the aging resistance of steel, and the decrease is significant if N content is more than 0.008%. Therefore, N content is 0.008% or less.

The remainder consists of Fe and inevitable impurities. However, at least one of the following elements may be added as needed to the chemical composition described above.

### Cr: 0.05 to 1.0%, V: 0.005 to 0.5%, Mo: 0.005 to 0.5%

Cr, V and Mo may be added as needed because they are effective to improve the balance between strength and ductility. The effect is realized if Cr content is 0.05% or more, if V content is 0.005% or more, or if Mo content is 0.005% or more. However, excessive addition of more than 1.0% of Cr, excessive addition of more than 0.5% of V, or excessive addition of more than 0.5% of Mo causes concerns of, for example, there being a significant increase in strength due to an excessive fraction constituted by the second phase and an increase in cost at the same time. Therefore, in the case where these chemical elements are added, Cr content is set to be 0.05 to 1.0%, V content is 0.005 to 0.5% and Mo content is 0.005 to 0.5%.

### Ni: 0.05 to 1.0%, Cu: 0.05 to 1.0%

Ni and Cu are chemical elements that are effective to strengthen steel, and these chemical elements may be added to strengthen steel as long as the added amount is within the desired limits. Moreover, these elements improve coating adhesion by accelerating internal oxidation. A content of Ni or Cu of 0.05% or more is necessary to realize these effects. On the other hand, excessive addition of more than 1.0% of Ni or Cu causes a decrease in formability of steel, increasing cost at the same time. Therefore, in the case where these chemical elements are added, Ni content is 0.05 to 1.0% and Cu content is 0.05 to 1.0%.

Moreover, at least one of the chemical elements among Ti, Nb and B described below may be added.

### Ti: 0.01 to 0.1%, Nb: 0.01 to 0.1%

Ti and Nb are effective in precipitation strengthening of steel, which is realized if the content of Ti or Nb is 0.01% or more. These chemical elements may be added to strengthen steel as long as the added amount is within the desired limits. However, excessive addition of more than 0.1% of Ti or Nb causes a decrease in formability and shape fixability, increasing cost at the same time. Therefore, in the case where these chemical elements are added, Ti content is 0.01 to 0.1% and Nb content is 0.01 to 0.1%.

### B: 0.0003 to 0.0050%

B may be added as needed because B is effective in suppressing generation and growth of ferrite from the grain boundaries of austenite. This effect is realized if B content is 0.0003% or more. However, excessive addition of more than 0.0050% of B causes a decrease in formability, increasing cost at the same time. Therefore, in the case where B is added, B content is 0.0003 to 0.0050%.

Moreover, at least one of the following chemical elements may be added.

### Ca: 0.001 to 0.005%, REM: 0.001 to 0.005%

Ca and REM are chemical elements effective to globularize sulfide and reduce the negative influence of sulfide on stretch flangeability. This effect is realized if the content of Ca or REM is 0.001% or more. However, excessive addition of more than 0.005% of Ca or REM causes an increase in inclusions and so forth, which results in surface and internal defects. Therefore, in the case where these chemical elements are added, Ca content is 0.001 to 0.005% and REM content is 0.001 to 0.005%.

### Ta: 0.001 to 0.010%, Sn: 0.002 to 0.2%

It is thought that Ta not only forms alloy carbide and alloy carbonitride, similarly to Ti and Nb, and contributes to strengthening, but is also effective in stabilizing the contribution to strengthening via precipitation strengthening by significantly suppressing the coarsening of precipitates by forming a solid solution in Nb carbide or Nb carbonitride and forming complex precipitates such as (Nb, Ta)(C, N). Therefore, in the case where Ta is added, it is preferable that Ta content be 0.001% or more. However, excessive addition of Ta causes an increase in cost, whereas there is no further increase in effect in stabilizing the precipitates described above. Therefore, in the case where Ta is added, Ta content is 0.010% or less.

Sn may be added from the viewpoint of suppressing nitridation or oxidation of the surface of a steel sheet or decarburization which is caused by oxidation in the surface layer of a steel sheet, the depth of which is several tens of μm. A decrease in the amount of martensite formed at the surface of a steel sheet is avoided by suppressing nitridation or oxidation described above, which results in improvement of fatigue resistance and aging resistance. In the case where Sn is added from the viewpoint of suppressing nitridation or oxidation, it is preferable that Sn content be 0.002% or more, and that Sn content be 0.2% or less, because excessive addition of more than 0.2% of Sn causes a decrease in the toughness of steel.

### Sb: 0.002 to 0.2%

Sb may be added, similarly to Sn, from the viewpoint of suppressing nitridation or oxidation of the surface of a steel sheet or decarburization which is caused by oxidation in the surface layer of a steel sheet, the depth of which is several tens of μm. A decrease in the amount of martensite formed at the surface of a steel sheet is avoided by suppressing nitridation or oxidation mentioned above, which results in improvement of fatigue resistance and aging resistance. In the case where Sb is added from the viewpoint of suppressing nitridation or oxidation, it is preferable that Sb content is 0.002% or more, and Sb content is 0.2% or less because excessive addition of more than 0.2% of Sb causes a decrease in toughness of steel.

2) Secondly, the microstructure will be described below.
The area ratio of ferrite: 80% or more

It is necessary that the area ratio of ferrite be 80% or more to ensure good stretch flangeability by decreasing the size of the interface between soft ferrite and hard martensite. The area ratio of bainitic ferrite: 1.0% or more

It is necessary that the area ratio of bainitic ferrite be 1.0% or more to ensure good stretch flangeability by reducing the difference in hardness between soft ferrite and hard martensite.

The area ratio of pearlite: 1.0 to 10.0%

It is necessary that the area ratio of pearlite be 1.0% or more to ensure good stretch flangeability. Moreover, it is necessary that the area ratio of pearlite be 10.0% or less to attain the specified strength.

The area ratio of martensite: 1.0% or more and less than 5.0%

It is necessary that the area ratio of martensite be 1.0% or more to attain the specified strength. Moreover, it is necessary that the area ratio of martensite be less than 5.0% to ensure good stretch flangeability because an excessive area ratio of martensite has a great effect on stretch flangeability.

The area ratio of martensite/(the area ratio of bainitic ferrite+the area ratio of pearlite) 0.6

It is necessary to ensure good stretch flangeability that the amount of martensite which is proportional to the size of interface in phases which are significantly different in hardness from each other be reduced and that the amount of bainitic ferrite or pearlite which is softer than martensite be increased. This means that it is necessary that the following inequality be satisfied: the area ratio of martensite/(the area ratio of bainitic ferrite+the area ratio of pearlite) 0.6.

The mean grain size of ferrite: 14 μm or less

The mean grain size of ferrite is 14 μm or less to attain the specified strength and fatigue resistance.

The mean grain size of martensite: 4 μm or less

The mean grain size of martensite is 4 μm or less to ensure good fatigue resistance and stretch flangeability.

The mean free path of martensite: 3 μm or more

It is necessary that the mean free path of martensite be 3 μm or more to ensure good fatigue resistance and stretch flangeability.

The Vickers hardness of ferrite: 140 or more

It is necessary that the Vickers hardness of ferrite be 140 or more to ensure good fatigue resistance.

Note that, even in the case where retained austenite, tempered martensite, or a carbide including cementite is formed, good fatigue resistance and stretch flangeability are achieved as long as the conditions including those regarding the area ratio of ferrite, bainitic ferrite, pearlite, and martensite are satisfied as described above.

Moreover, herein, the area ratio of ferrite, bainitic ferrite, pearlite, or martensite shall refer to the ratio of area occupied by each phase against the total observed area.

3) Third, the manufacturing conditions will be described below.

The high strength galvanized steel sheet can be manufactured by a method in which a slab having a chemical composition conforming to the limits described above undergoes hot rolling and pickling, then, after or without undergoing cold rolling, is heated to a temperature in a range of 700° C. or higher at a mean heating rate of 8° C./s or more, is held in a temperature range of 800 to 900° C. for 15 to 600 seconds, then after being allowed to cool, is held in a temperature range of 450 to 550° C. for 10 to 200 seconds and then is subjected to galvanization.

In another method, the slab further undergoes alloying treatment for the galvanized layer in a temperature range of 500 to 600° C. under conditions that satisfy the following inequality: 0.45≦exp [200/(400−T)]×In(t)≦1.0, where T denotes a mean holding temperature in units of ° C., t denotes a holding time in units of s, exp(X) denotes the exponential of X and In(X) denotes the natural logarithm of X. The details of this method will be described below.

The steel having the chemical composition described above is usually smelted by a known process, made into a slab by using blooming or continuous casting process and is then made into a hot coil by hot rolling. It is preferable that the slab be heated up to a temperature in a range of 1100 to 1300° C., hot-rolled with a finish rolling temperature of 850° C. or higher and coiled into a hot strip coil in a temperature range of 400 to 650° C. There might be a case where a specified strength is not obtained, if the finish rolling temperature is higher than 650° C. because there is a coarsening of carbides in the hot strip and the coarse carbides cannot dissolve during soaking in annealing. The strip, then, after undergoing pre-treatment including pickling and degreasing by known methods, is cold-rolled as needed. Although it is unnecessary to limit the conditions under which cold rolling is performed, it is preferable that the reduction ratio achieved by cold rolling be 30% or more. In the case where the reduction ratio achieved by cold rolling is small, the recrystallization of ferrite is not accelerated and non-crystallized ferrite remains, which may result in a decrease in ductility and stretch flangeability.

Heating up to a temperature in a range of 700° C. or higher at a mean heating rate of 8° C/s or more

In the case where a mean heating rate up to a temperature in a range of 700° C. or higher is less than 8° C./s, fine and uniformly dispersed ferrite is not generated in annealing and the second phase is concentrated locally in the final microstructure, and then the final microstructure in which martensite is concentrated locally is formed, which results in difficulty in ensuring good fatigue resistance and stretch flangeability. Moreover, there is an increase in cost due to the large energy consumption and a decrease in productivity because a longer furnace than usual is needed. It is preferable that DFF (Direct Fired Furnace) be used as a heating furnace. This is because rapid heating by DFF ensures generation of an internal oxidation layer, prevention of the concentration of oxides of Si, Mn and so forth in the outermost layer of the steel sheet, and good coating wettability.

Holding in a temperature range of 800 to 900° C. for 15 to 600 seconds

The strip is annealed (i.e., held) in a temperature range of 800 to 900° C., which specifically means for a single phase of austenite or a dual phase of austenite and ferrite, for 15 to 600 seconds. In the case where the annealing temperature is lower than 800° C. or where the holding time is shorter than 15 s, there may be a case where hard cementite in the steel does not sufficiently dissolve or where recrystallization of ferrite is not completed, which would result in a decrease in fatigue resistance and stretch flangeability. On the other hand, in the case where the annealing temperature is higher than 900° C., the grain size of austenite grows markedly and the area ratio of martensite increase in the final microstructure, which results in a decrease in stretch flangeability. Moreover, in the case where the holding (i.e., annealing) time is longer than 600 s, the coarsening of ferrite occurs in annealing and the mean grain size of ferrite in the final microstructure becomes more than 14 μm, which results not only in difficulty in ensuring the specified strength, but also in a decrease in fatigue resistance. In addition, there may be an increase in cost due to large energy consumption.

Holding in a temperature range of 450 to 550° C. for 10 to 200 seconds

In the case where the holding temperature is higher than 550° C. or where the holding time is shorter than 10 s, bainite transformation is not accelerated and bainitic ferrite is negligibly obtained, which results in the specified stretch flangeability not being able to be obtained. Moreover, in the case where the holding temperature is lower than 450° C. or where the holding time is longer than 200 s, the majority of the second phase consists of austenite and bainitic austenite which are rich in dissolved carbon formed by the accelerated bainite transformation, which results in the specified area ratio of pearlite and good stretch flangeability not being able to be obtained because of an increase in the area ratio of hard martensite.

After that, to improve corrosion resistance in actual use, the strip is galvanized in a coating bath of a typical temperature and the coating weight is adjusted by a method such as gas wiping.

A galvannealed steel sheet, which is manufactured by performing heat treatment after galvanizing so that Fe from the steel sheet defuses into the coated layer, is mostly used to ensure pressing formability, spot weldability and paint adhesion. In manufacturing of the galvannealed steel sheet, the galvanized steel sheet undergoes alloying treatment in a temperature range of 500 to 600° C. under the condition that satisfies the following inequality: 0.45≦exp [200/(400−T)]×In(t)≦1.0, where T denotes a mean holding temperature in units of ° C., t denotes a holding time in units of s, exp(X) denotes the exponential of X and In(X) denotes the natural logarithm of X.

In a temperature range lower than 500° C., it is difficult to obtain a galvanized steel sheet having the alloyed coated layer (GA steel) because the alloying of the coated layer is not accelerated. Moreover, in a temperature range higher than 600° C., the balance of strength and ductility decreases because the majority of the second phase becomes pearlite and the specified area ratio of martensite is not obtained.

In the case where exp [200/(400−T)]×In(t) is less than 0.45, there is a large amount of martensite in the final microstructure and this hard martensite is adjacent to soft ferrite, inducing a large difference in hardness between different phases, which results in a decrease in stretch flangeability and in poor adhesion of the galvanized layer.

In the case where exp [200/(400−T)]×In(t) is more than 1.0, the majority of untransformed austenite transforms into cementite or pearlite, which results in the specified strength not being able to be obtained.

Note that, it is not necessary that the holding temperature be constant in the series of heat treatments in the manufacturing method as long as the temperature is within the limits described above. Moreover, the steel sheet can be heat-treated in any kind of apparatus as long as the heat history satisfies the limits described above. In addition, our methods include skin pass rolling of the steel sheet to correct the shape of the steel sheet after heat treatment. Note that, although our methods have been described on the assumption that the steel is manufactured through the usual process including steel making, blooming and hot rolling, part of or the whole of hot rolling process may be omitted by using a process such as thin strip casting.

### EXAMPLES

The steel having the chemical composition given in Table 1 and the remainder consisting of Fe and inevitable impurities was smelted in a revolving furnace and made into a slab by using continuous casting. The obtained slab was, after being heated up to 1200° C., hot-rolled to a thickness of 1.8 to 3.4 mm with a finish rolling temperature in a range of 870 to 920° C. and coiled at a temperature of 520° C. Then, after the obtained hot strip was pickled, some part of the strip was retained as a pickled hot strip and the remaining part was cold-rolled into a cold strip. The hot strip having a thickness of 3.2 mm was selected to be cold-rolled.

Then, the pickled hot strip and the cold strip obtained through the process described above were annealed and galvanized in a continuous galvanizing line under the conditions given in Tables 2 and 3, and then, were treated by alloying treatment into galvanized steel sheets having the alloyed coated layer (GA steel). Some of the strips after galvanized were not treated by alloying treatment and remained galvanized steel sheets without an alloyed coated layer (GI steel). The coating weight per side was 30 to 50 g/m².

TABLE 1

| Steel | Chemical Composition (percent by mass) | | | | | | | | | | | | |
|---|---|---|---|---|---|---|---|---|---|---|---|---|---|
| Grade | C | Si | Mn | Al | P | S | N | Ni | Cu | Cr | V | Mo | Nb |
| A | 0.089 | 1.46 | 1.37 | 0.032 | 0.014 | 0.0018 | 0.0025 | — | — | — | — | — | — |
| B | 0.110 | 1.41 | 1.21 | 0.031 | 0.016 | 0.0019 | 0.0028 | — | — | — | — | — | — |
| C | 0.061 | 1.52 | 1.61 | 0.032 | 0.019 | 0.0022 | 0.0027 | — | — | — | — | — | — |
| D | 0.081 | 1.40 | 1.32 | 0.028 | 0.018 | 0.0019 | 0.0030 | — | — | 0.21 | — | — | — |
| E | 0.072 | 1.51 | 1.28 | 0.033 | 0.012 | 0.0018 | 0.0031 | — | — | — | 0.061 | — | — |
| F | 0.092 | 1.34 | 1.39 | 0.030 | 0.015 | 0.0024 | 0.0030 | — | — | — | — | 0.051 | — |
| G | 0.078 | 1.52 | 1.42 | 0.031 | 0.010 | 0.0025 | 0.0030 | — | — | — | — | — | 0.031 |
| H | 0.081 | 1.42 | 1.31 | 0.039 | 0.020 | 0.0027 | 0.0029 | — | — | — | — | — | — |
| I | 0.076 | 1.50 | 1.21 | 0.030 | 0.018 | 0.0020 | 0.0036 | 0.19 | 0.21 | — | — | — | — |
| J | 0.091 | 1.39 | 1.55 | 0.030 | 0.009 | 0.0030 | 0.0033 | — | — | — | — | — | — |
| K | 0.158 | 1.32 | 1.42 | 0.039 | 0.020 | 0.0022 | 0.0034 | — | — | — | — | — | — |
| L | 0.093 | 0.79 | 1.68 | 0.032 | 0.015 | 0.0018 | 0.0028 | — | — | — | — | — | — |
| M | 0.050 | 1.17 | 2.19 | 0.030 | 0.016 | 0.0022 | 0.0033 | — | — | — | — | — | — |
| AB | 0.092 | 1.46 | 1.42 | 0.028 | 0.019 | 0.0012 | 0.0030 | — | — | — | — | — | 0.010 |
| AC | 0.091 | 1.45 | 1.41 | 0.029 | 0.017 | 0.0015 | 0.0031 | — | — | — | — | — | 0.011 |
| AD | 0.086 | 1.50 | 1.43 | 0.026 | 0.016 | 0.0011 | 0.0029 | — | — | — | — | — | — |
| AE | 0.084 | 1.51 | 1.44 | 0.031 | 0.021 | 0.0021 | 0.0022 | — | — | — | — | — | — |

| Steel | Chemical Composition (percent by mass) | | | | | | | |
|---|---|---|---|---|---|---|---|---|
| Grade | Ti | B | Ca | REM | Ta | Sn | Sb | Note |
| A | — | — | — | — | | | | Example |
| B | — | — | — | — | | | | Example |
| C | — | — | — | — | | | | Example |
| D | — | — | — | — | | | | Example |
| E | — | — | — | — | | | | Example |
| F | — | — | — | — | | | | Example |
| G | — | — | — | — | | | | Example |
| H | 0.019 | 0.0021 | — | — | | | | Example |
| I | — | — | — | — | | | | Example |
| J | — | — | 0.0012 | 0.0018 | | | | Example |
| K | — | — | — | — | | | | Comparative |
| | | | | | | | | Example |
| L | — | — | — | — | | | | Comparative |
| | | | | | | | | Example |
| M | — | — | — | — | | | | Comparative |
| | | | | | | | | Example |
| AB | — | — | — | — | 0.008 | — | — | Example |
| AC | — | — | — | — | — | 0.007 | — | Example |
| AD | — | — | — | — | 0.005 | — | — | Example |
| AE | — | — | — | — | — | — | 0.008 | Example |

Underlined Part: Out of the Limit

TABLE 2

| | | | | | | | | | | Mean | | | |
|---|---|---|---|---|---|---|---|---|---|---|---|---|---|
| | | | | | Mean | | | Mean Holding | Holding Time | Holding | | | |
| | | | | Heating | Heating | Annealing | | Temperature Between | Between Cooling | Temperature | Holding | | |
| | Steel | Cold | Thickness | Temperature | Rate | Temperature | Annealing | Cooling and Dipping | and Dipping | for Alloying | Time for | exp[200/(400 − T)] × | |
| No. | Grade | Rolling | (mm) | ° C. | ° C./s | ° C. | Time s | into a Coating Bath ° C. | into a Coating Bath s | ° C. | Alloying s | ln(t) | Note |
| 1 | A | Performed | 1.4 | 745 | 12 | 845 | 170 | 500 | 60 | 560 | 15 | 0.776 | Example |
| 2 | A | Performed | 1.4 | 740 | 13 | 850 | 160 | 495 | 50 | — | — | — | Example |
| 3 | A | Performed | 1.4 | 600 | 11 | 855 | 160 | 500 | 50 | 565 | 17 | 0.843 | Comparative |
| | | | | | | | | | | | | | Example |
| 4 | B | Performed | 1.4 | 750 | 4 | 800 | 170 | 495 | 55 | 570 | 14 | 0.814 | Comparative |
| | | | | | | | | | | | | | Example |
| 5 | B | Performed | 1.4 | 720 | 10 | 700 | 180 | 490 | 65 | 555 | 16 | 0.763 | Comparative |
| | | | | | | | | | | | | | Example |
| 6 | B | Performed | 1.4 | 730 | 12 | 920 | 200 | 485 | 60 | 560 | 18 | 0.828 | Comparative |
| | | | | | | | | | | | | | Example |
| 7 | B | Performed | 1.2 | 750 | 12 | 850 | 160 | 510 | 55 | 565 | 14 | 0.785 | Example |
| 8 | B | Performed | 1.2 | 740 | 12 | 855 | 800 | 500 | 60 | 580 | 12 | 0.818 | Comparative |
| | | | | | | | | | | | | | Example |
| 9 | B | Performed | 1.2 | 730 | 13 | 840 | 6 | 490 | 55 | 570 | 13 | 0.791 | Comparative |
| | | | | | | | | | | | | | Example |
| 10 | C | Performed | 1.6 | 740 | 14 | 840 | 170 | 485 | 60 | 570 | 14 | 0.814 | Example |
| 11 | C | Performed | 1.6 | 750 | 10 | 840 | 180 | 610 | 45 | 560 | 17 | 0.812 | Comparative |
| | | | | | | | | | | | | | Example |
| 12 | C | Performed | 1.6 | 760 | 11 | 845 | 170 | 330 | 50 | 555 | 16 | 0.763 | Comparative |
| | | | | | | | | | | | | | Example |
| 13 | C | Performed | 1.6 | 750 | 13 | 815 | 170 | 490 | 3 | 545 | 15 | 0.682 | Comparative |
| | | | | | | | | | | | | | Example |
| 14 | C | Performed | 1.6 | 730 | 11 | 820 | 180 | 500 | 420 | 565 | 18 | 0.860 | Comparative |
| | | | | | | | | | | | | | Example |
| 15 | C | Performed | 1.6 | 730 | 12 | 840 | 200 | 505 | 50 | 565 | 50 | 1.164 | Comparative |
| | | | | | | | | | | | | | Example |
| 16 | C | Performed | 1.6 | 740 | 14 | 830 | 180 | 510 | 55 | 555 | 4 | 0.381 | Comparative |
| | | | | | | | | | | | | | Example |
| 17 | C | Performed | 1.6 | 730 | 15 | 850 | 160 | 485 | 60 | 670 | 17 | 1.351 | Comparative |
| | | | | | | | | | | | | | Example |
| 18 | C | Performed | 1.6 | 720 | 10 | 820 | 170 | 490 | 65 | 450 | 18 | 0.053 | Comparative |
| | | | | | | | | | | | | | Example |
| 19 | D | Performed | 1.8 | 750 | 11 | 850 | 190 | 495 | 80 | 560 | 18 | 0.828 | Example |
| 20 | E | Performed | 1.6 | 760 | 11 | 810 | 160 | 495 | 70 | 575 | 16 | 0.884 | Example |
| 21 | F | Performed | 2.3 | 750 | 10 | 850 | 260 | 500 | 110 | 555 | 22 | 0.851 | Example |
| 22 | G | Performed | 2.1 | 720 | 11 | 820 | 230 | 520 | 90 | 555 | 20 | 0.824 | Example |
| 23 | H | Performed | 1.0 | 750 | 15 | 840 | 110 | 510 | 110 | 570 | 14 | 0.814 | Example |
| 24 | I | Performed | 1.2 | 720 | 11 | 825 | 140 | 540 | 40 | 555 | 14 | 0.726 | Example |
| 25 | J | Performed | 1.4 | 750 | 10 | 840 | 170 | 495 | 60 | 550 | 15 | 0.714 | Example |
| 26 | K | Performed | 1.8 | 730 | 12 | 860 | 210 | 490 | 70 | 560 | 17 | 0.812 | Comparative |
| | | | | | | | | | | | | | Example |
| 27 | L | Performed | 1.2 | 750 | 12 | 830 | 160 | 540 | 45 | 565 | 15 | 0.806 | Comparative |
| | | | | | | | | | | | | | Example |
| 28 | M | Performed | 1.4 | 740 | 14 | 820 | 180 | 500 | 55 | 560 | 12 | 0.712 | Comparative |
| | | | | | | | | | | | | | Example |
| 29 | A | Not | 2.3 | 710 | 11 | 850 | 210 | 495 | 100 | 555 | 24 | 0.875 | Example |
| | | Performed | | | | | | | | | | | |
| 30 | A | Not | 2.6 | 715 | 11 | 810 | 230 | 495 | 110 | 550 | 23 | 0.827 | Example |
| | | Performed | | | | | | | | | | | |
| 31 | B | Not | 2.3 | 710 | 11 | 850 | 220 | 495 | 90 | — | — | — | Example |
| | | Performed | | | | | | | | | | | |
| 32 | C | Not | 2.1 | 710 | 11 | 820 | 200 | 495 | 100 | 555 | 25 | 0.886 | Example |
| | | Performed | | | | | | | | | | | |
| 33 | D | Not | 2.0 | 710 | 10 | 860 | 120 | 495 | 40 | 570 | 10 | 0.710 | Example |
| | | Performed | | | | | | | | | | | |
| 34 | E | Not | 1.8 | 705 | 11 | 840 | 130 | 495 | 50 | 565 | 13 | 0.763 | Example |
| | | Performed | | | | | | | | | | | |
| 35 | F | Not | 3.4 | 710 | 14 | 840 | 160 | 500 | 100 | 570 | 14 | 0.814 | Example |
| | | Performed | | | | | | | | | | | |
| 36 | G | Not | 2.6 | 720 | 11 | 840 | 170 | 520 | 65 | 560 | 15 | 0.776 | Example |
| | | Performed | | | | | | | | | | | |
| 37 | H | Not | 2.2 | 705 | 10 | 825 | 190 | 510 | 75 | 550 | 17 | 0.747 | Example |
| | | Performed | | | | | | | | | | | |
| 38 | I | Not | 2.0 | 705 | 16 | 840 | 210 | 540 | 85 | 580 | 16 | 0.913 | Example |
| | | Performed | | | | | | | | | | | |
| 39 | J | Not | 2.3 | 710 | 13 | 850 | 220 | 495 | 100 | 570 | 14 | 0.814 | Example |
| | | Performed | | | | | | | | | | | |

Underlined Part: Out of the Limit

TABLE 3

| | | | | | | | | Mean Holding | | Mean | | | |
|---|---|---|---|---|---|---|---|---|---|---|---|---|---|
| | | | | Heat- | | Anneal- | | Temperature | Holding Time | Holding | Holding | | |
| | | | | ing | Mean | ing | | Between | Between | Temper- | Time | | |
| | | | | Tem- | Heat- | Tem- | | Cooling | Cooling | ature | for | exp[200/ | |
| | | | Thick- | per- | ing | per- | Anneal- | and Dipping | and Dipping | for | Alloy- | (400 − | |
| | Steel | Cold | ness | ature | Rate | ature | ing | into a Coating | into a Coating | Alloying | ing | T)] × | |
| No. | Grade | Rolling | (mm) | ° C. | ° C./s | ° C. | Time s | Bath ° C. | Bath s | ° C. | s | ln(t) | Note |
| 40 | AB | Performed | 1.2 | 700 | 10 | 800 | 130 | 490 | 50 | 540 | 14 | 0.632 | Example |
| 41 | AC | Performed | 1.2 | 710 | 9 | 800 | 140 | 480 | 40 | 540 | 15 | 0.649 | Example |
| 42 | AD | Performed | 1.2 | 700 | 9 | 800 | 120 | 490 | 45 | 535 | 13 | 0.583 | Example |
| 43 | AE | Performed | 1.2 | 720 | 10 | 800 | 150 | 495 | 50 | 545 | 14 | 0.664 | Example |
| 44 | A | Performed | 1.2 | 710 | 9 | 800 | 130 | 480 | 45 | 530 | 13 | 0.551 | Example |
| 45 | A | Performed | 2.0 | 700 | 9 | 800 | 210 | 475 | 85 | 540 | 21 | 0.730 | Example |

The area ratios of ferrite, bainitic ferrite, pearlite and martensite and the mean grain sizes of ferrite and martensite, where the grain size of ferrite is denoted by d_{F} and that of martensite is denoted by d_{M}, were obtained by using Image-Pro manufactured by Media Cybernetics, Inc., analyzing the data observed by using SEM (Scanning Electron Microscope) at 2000-fold magnification in 10 fields for each specimen taken from a cross section in the thickness direction parallel to the rolling direction of the obtained galvanized steel sheet (GI steel sheet, GA steel sheet) and which was corroded with a 3% nital solution after being polished. The mean grain size was derived from an equivalent circle diameter. Moreover, as it is difficult to distinguish between martensite and retained austenite, the area ratio of the martensite phase was defined as an area ratio of a tempered martensite phase obtained through the method described above from the data observed through the method described above in a cross section in the thickness direction parallel to the rolling direction taken from the obtained galvanized steel sheet which was tempered at a temperature of 200° C. for 2 hours. Moreover, the volume fraction of the retained austenite phase was obtained by using diffracted X-ray intensity analysis at a cross section at the depth of a quarter of the thickness exposed by polishing the steel sheet in the thickness direction. The volume fraction of retained austenite phase was defined as a mean value of the intensity ratios obtained for all of the combinations of peak integrated intensity of {111}, {200}, {220}, {311} planes of retained austenite phase and {110}, {200}, {211} planes of ferrite phase. The mean free path (L_{M}) of martensite was derived from the equation below, where d_{M} denotes the mean grain size of martensite and V_{M} denotes the area ratio of martensite phase:

$${L}_{M} = \frac{{d}_{M}}{2} {( \frac{4 π}{3 {V}_{M}} )}^{\frac{1}{3}} . \qquad Equation 1$$

Moreover, the hardness of ferrite was defined as a mean value of hardness measured using a micro Vickers hardness meter at 10 points in a crystal grain of ferrite.

The tensile test was carried out while conforming to JIS Z 2241 with JIS No. 5 tensile test pieces cut out of the steel sheet so that the tensile direction was perpendicular to the rolling direction to measure TS (tensile strength) and El (total elongation). Moreover, the fatigue strength was defined as the largest stress with which 10⁷ cycles were completed without a fracture occurring in a completely reversed plane bending test. A result was judged as satisfactory if fatigue strength ≧280 MPa.

A hole expanding test was carried out while conforming to The Japan Iron and Steel Federation Standard JFS T 1001. A hole having a diameter of 10 mm was punched in a sample of 100 mm×100 mm cut out of the obtained steel sheet, with a clearance of 12%±1% in the case of a thickness 2.0 mm and 12%±2% for a thickness <2.0 mm, then the sample was set in a die having an internal diameter of 75 mm with a blank holding force of 9 tons and a conical punch having a vertex angle of 60° was made to penetrate into the hole, and the diameter of the hole was measured at the cracking limit. The stretch flangeability was estimated with the limit hole expansion ratio λ(%) which is derived from the following equation: limit hole expansion ratio λ(%)={(D_{f}−D₀)/D₀}×100, where D_{f} denotes the hole diameter (mm) at the cracking limit and D₀ denotes the initial hole diameter (mm) A result was judged as satisfactory if λ≧80(%).

The results obtained by the method described above are given in Tables 4 and 5.

TABLE 4

| | | | Area | Area | Area | Area | | | | | | | | | | | |
|---|---|---|---|---|---|---|---|---|---|---|---|---|---|---|---|---|---|
| | | | Ratio | Ratio | Ratio | Ratio | Volume | | | | | Hv | | | | | |
| | | Thick- | of | of | of | of | fraction | M/ | | | | Hard- | | | | Fatigue | |
| | Steel | ness | F | M | BF | P | of RA | (BF + | d_{F} | d_{M} | L_{M} | ness | TS | El | λ | Strength | |
| No. | Grade | (mm) | (%) | (%) | (%) | (%) | (%) | P) | (μm) | (μm) | (μm) | of F | (MPa) | (%) | (%) | (MPa) | Note |
| 1 | A | 1.4 | 86.7 | 2.2 | 4.5 | 4.9 | 1.2 | 0.23 | 9.0 | 2.4 | 5.1 | 158 | 629 | 32.9 | 114 | 321 | Example |
| 2 | A | 1.4 | 87.4 | 2.4 | 3.8 | 5.1 | 0.9 | 0.27 | 8.7 | 2.6 | 5.6 | 152 | 622 | 33.6 | 101 | 313 | Example |
| 3 | A | 1.4 | 87.4 | 3.5 | 3.4 | 4.5 | 0.8 | 0.44 | 7.8 | 5.2 | 2.1 | 151 | 631 | 30.8 | 65 | 248 | Comparative |
| | | | | | | | | | | | | | | | | | Example |
| 4 | B | 1.4 | 86.5 | 3.8 | 4.0 | 4.2 | 1.2 | 0.46 | 7.7 | 5.3 | 2.4 | 149 | 629 | 29.7 | 62 | 247 | Comparative |
| | | | | | | | | | | | | | | | | | Example |
| 5 | B | 1.4 | 83.6 | 4.8 | 2.9 | 3.5 | 1.1 | 0.75 | 7.5 | 3.3 | 4.5 | 152 | 639 | 28.8 | 55 | 251 | Comparative |
| | | | | | | | | | | | | | | | | | Example |
| 6 | B | 1.4 | 87.3 | 6.1 | 0.9 | 3.7 | 0.3 | 1.33 | 7.9 | 2.8 | 4.4 | 153 | 638 | 29.9 | 50 | 260 | Comparative |
| | | | | | | | | | | | | | | | | | Example |
| 7 | B | 1.2 | 87.4 | 3.1 | 4.0 | 3.4 | 1.5 | 0.42 | 7.9 | 2.6 | 5.4 | 158 | 632 | 33.1 | 111 | 311 | Example |
| 8 | B | 1.2 | 83.2 | 4.2 | 3.2 | 6.2 | 0.1 | 0.45 | 15.8 | 3.1 | 4.8 | 141 | 574 | 30.3 | 81 | 248 | Comparative |
| | | | | | | | | | | | | | | | | | Example |
| 9 | B | 1.2 | 88.2 | 2.2 | 0.8 | 7.2 | 0.5 | 0.28 | 8.0 | 3.2 | 4.6 | 149 | 622 | 29.8 | 58 | 248 | Comparative |
| | | | | | | | | | | | | | | | | | Example |
| 10 | C | 1.6 | 87.8 | 2.1 | 4.1 | 4.6 | 0.9 | 0.24 | 9.6 | 2.4 | 6.0 | 158 | 640 | 33.1 | 100 | 316 | Example |
| 11 | C | 1.6 | 86.5 | 3.8 | 0.6 | 7.6 | 0.5 | 0.46 | 8.0 | 2.8 | 5.1 | 149 | 620 | 29.1 | 60 | 262 | Comparative |
| | | | | | | | | | | | | | | | | | Example |
| 12 | C | 1.6 | 85.1 | 8.2 | 3.3 | 0.7 | 1.5 | 2.05 | 7.8 | 4.8 | 2.2 | 150 | 610 | 28.9 | 50 | 267 | Comparative |
| | | | | | | | | | | | | | | | | | Example |
| 13 | C | 1.6 | 86.8 | 4.8 | 0.2 | 7.2 | 0.2 | 0.65 | 7.9 | 2.8 | 5.1 | 152 | 640 | 27.9 | 66 | 267 | Comparative |
| | | | | | | | | | | | | | | | | | Example |
| 14 | C | 1.6 | 82.3 | 0.7 | 6.5 | 10.3 | 0.1 | 0.04 | 8.2 | 2.8 | 5.1 | 153 | 538 | 30.1 | 68 | 260 | Comparative |
| | | | | | | | | | | | | | | | | | Example |
| 15 | C | 1.6 | 84.1 | 0.5 | 4.5 | 10.4 | 0.3 | 0.03 | 7.4 | 2.8 | 5.1 | 150 | 575 | 28.4 | 87 | 258 | Comparative |
| | | | | | | | | | | | | | | | | | Example |
| 16 | C | 1.6 | 79.1 | 6.3 | 8.4 | 1.6 | 3.8 | 0.63 | 7.5 | 5.1 | 2.3 | 152 | 654 | 29.2 | 50 | 260 | Comparative |
| | | | | | | | | | | | | | | | | | Example |
| 17 | C | 1.6 | 84.2 | 0.3 | 4.4 | 10.5 | 0.2 | 0.02 | 7.6 | 2.8 | 5.1 | 151 | 578 | 30.8 | 88 | 265 | Comparative |
| | | | | | | | | | | | | | | | | | Example |
| 18 | C | 1.6 | 79.1 | 6.5 | 8.4 | 1.4 | 4.1 | 0.66 | 7.9 | 4.9 | 2.2 | 154 | 650 | 29.2 | 55 | 261 | Comparative |
| | | | | | | | | | | | | | | | | | Example |
| 19 | D | 1.8 | 87.8 | 1.8 | 4.0 | 5.1 | 0.8 | 0.20 | 9.0 | 2.5 | 6.2 | 160 | 622 | 34.0 | 112 | 322 | Example |
| 20 | E | 1.6 | 87.6 | 2.3 | 3.9 | 4.8 | 1.0 | 0.26 | 8.7 | 2.0 | 6.4 | 152 | 630 | 33.1 | 111 | 318 | Example |
| 21 | F | 2.3 | 86.2 | 1.2 | 4.3 | 6.1 | 1.9 | 0.12 | 10.1 | 2.1 | 5.2 | 155 | 625 | 35.6 | 121 | 309 | Example |
| 22 | G | 2.1 | 87.2 | 1.9 | 4.0 | 5.1 | 1.4 | 0.21 | 10.8 | 2.5 | 4.9 | 159 | 626 | 34.7 | 116 | 310 | Example |
| 23 | H | 1.0 | 86.8 | 3.2 | 4.2 | 3.4 | 2.0 | 0.42 | 7.8 | 2.4 | 5.6 | 162 | 645 | 32.0 | 98 | 305 | Example |
| 24 | I | 1.2 | 86.2 | 3.1 | 5.2 | 2.8 | 2.3 | 0.39 | 8.2 | 2.3 | 5.8 | 154 | 632 | 32.3 | 103 | 331 | Example |
| 25 | J | 1.4 | 87.1 | 2.3 | 4.2 | 4.8 | 1.2 | 0.26 | 8.5 | 2.0 | 6.1 | 150 | 625 | 32.9 | 107 | 324 | Example |
| 26 | K | 1.8 | 81.4 | 14.3 | 0.6 | 0.8 | 2.0 | 10.21 | 9.1 | 5.2 | 2.5 | 147 | 641 | 32.1 | 53 | 284 | Comparative |
| | | | | | | | | | | | | | | | | | Example |
| 27 | L | 1.2 | 86.0 | 12.1 | 0.3 | 0.4 | 0.6 | 17.29 | 8.2 | 2.9 | 7.8 | 130 | 635 | 29.0 | 61 | 268 | Comparative |
| | | | | | | | | | | | | | | | | | Example |
| 28 | M | 1.4 | 82.6 | 13.4 | 0.8 | 0.7 | 2.1 | 8.93 | 8.4 | 4.8 | 2.2 | 143 | 624 | 30.2 | 60 | 292 | Comparative |
| | | | | | | | | | | | | | | | | | Example |
| 29 | A | 2.3 | 87.7 | 1.8 | 3.9 | 4.9 | 1.0 | 0.20 | 10.1 | 2.4 | 4.9 | 160 | 614 | 34.5 | 120 | 307 | Example |
| 30 | A | 2.6 | 87.7 | 2.1 | 3.4 | 5.1 | 0.8 | 0.25 | 10.2 | 2.7 | 5.2 | 158 | 610 | 35.5 | 130 | 310 | Example |
| 31 | B | 2.3 | 88.4 | 2.0 | 3.6 | 4.8 | 0.6 | 0.24 | 9.7 | 2.1 | 5.6 | 157 | 630 | 34.9 | 114 | 320 | Example |
| 32 | C | 2.1 | 86.8 | 2.1 | 3.8 | 6.1 | 0.8 | 0.21 | 10.2 | 2.8 | 5.8 | 153 | 620 | 34.5 | 118 | 308 | Example |
| 33 | D | 2.0 | 87.6 | 1.8 | 4.2 | 5.1 | 0.9 | 0.19 | 10.5 | 2.6 | 5.6 | 156 | 618 | 34.2 | 114 | 321 | Example |
| 34 | E | 1.8 | 88.4 | 2.2 | 4.1 | 3.4 | 1.4 | 0.29 | 10.8 | 2.5 | 5.2 | 161 | 622 | 33.5 | 112 | 310 | Example |
| 35 | F | 3.4 | 87.6 | 2.0 | 4.3 | 5.0 | 0.8 | 0.22 | 10.7 | 2.6 | 4.9 | 162 | 608 | 35.8 | 131 | 331 | Example |
| 36 | G | 2.6 | 87.9 | 2.1 | 4.4 | 4.5 | 0.6 | 0.24 | 9.8 | 2.4 | 4.8 | 152 | 610 | 35.4 | 136 | 320 | Example |
| 37 | H | 2.2 | 88.1 | 1.8 | 3.9 | 4.8 | 0.7 | 0.21 | 9.6 | 2.2 | 5.6 | 153 | 617 | 34.4 | 119 | 325 | Example |
| 38 | I | 2.0 | 88.9 | 1.9 | 3.8 | 3.9 | 0.9 | 0.25 | 10.5 | 2.0 | 6.1 | 157 | 610 | 34.0 | 121 | 310 | Example |
| 39 | J | 2.3 | 89.1 | 1.9 | 3.9 | 3.4 | 1.1 | 0.26 | 10.7 | 2.3 | 5.1 | 159 | 609 | 35.1 | 132 | 309 | Example |

Underlined Part: Out of the Limits
F: Ferrite
M: Martensite
BF: Bainitic Ferrite
P: Pearlite
RA: Retained Austenite
Hv: Hardness: Vickers Hardness
M/(BF + P): the Area Ratio of Martensite/(the Area Ratio of Bainitic Ferrite + the Area Ratio of Pearlite)

TABLE 5

| | | | Area | Area | Area | Area | | | | | | | | | | | |
|---|---|---|---|---|---|---|---|---|---|---|---|---|---|---|---|---|---|
| | | | Ratio | Ratio | Ratio | Ratio | Volume | | | | | Hv | | | | | |
| | | | of | of | of | of | fraction | M/ | | | | Hard- | | | | Fatigue | |
| | Steel | Thickness | F | M | BF | P | of RA | (BF + | d_{F} | d_{M} | L_{M} | ness | TS | El | λ | Strength | |
| No. | Grade | (mm) | (%) | (%) | (%) | (%) | (%) | P) | (μm) | (μm) | (μm) | of F | (MPa) | (%) | (%) | (MPa) | Note |
| 40 | AB | 1.2 | 86.9 | 2.3 | 4.4 | 4.8 | 1.4 | 0.25 | 8.8 | 2.5 | 5.2 | 160 | 628 | 32.5 | 107 | 326 | Example |
| 41 | AC | 1.2 | 87.3 | 2.5 | 3.7 | 4.9 | 0.9 | 0.29 | 8.1 | 2.8 | 5.8 | 155 | 622 | 33.3 | 105 | 321 | Example |
| 42 | AD | 1.2 | 87.6 | 3.1 | 3.9 | 3.6 | 1.2 | 0.41 | 7.7 | 2.6 | 5.1 | 161 | 630 | 33.1 | 110 | 320 | Example |
| 43 | AE | 1.2 | 87.8 | 2.6 | 5.1 | 3.2 | 1.0 | 0.31 | 8.2 | 2.3 | 5.8 | 159 | 624 | 32.8 | 103 | 332 | Example |
| 44 | A | 1.2 | 88.1 | 2.7 | 3.8 | 4.6 | 0.7 | 0.32 | 9.2 | 2.6 | 6.1 | 158 | 617 | 32.4 | 100 | 318 | Example |
| 45 | A | 2.0 | 87.4 | 1.9 | 4.3 | 5.0 | 0.8 | 0.20 | 10.2 | 2.4 | 5.1 | 162 | 618 | 35.6 | 118 | 330 | Example |

F: Ferrite
M: Martensite
BF: Bainitic Ferrite
P: Pearlite
RA: Retained Austenite
Hv: Hardness: Vickers Hardness
M/(BF + P): the Area Ratio of Martensite/(the Area Ratio of Bainitic Ferrite + the Area Ratio of Pearlite)

Our high strength galvanized steel sheets all have TS of 590 MPa or more and excellent fatigue resistance and excellent stretch flangeability. In contrast, all of the Comparative Examples are inferior in at least one of fatigue resistance and stretch flangeability.

### INDUSTRIAL APPLICABILITY

A high strength galvanized steel sheet having not only high strength, which means a TS of 590 MPa or more, but also excellent fatigue resistance and stretch flangeability can be obtained. The industrial utility of using the high strength galvanized steel sheet is very large because, for example, fuel efficiency is expected to be improved by decreasing the weight of an automobile body, if the steel sheet is applied to structural members of an automobile.

1. A high strength galvanized steel sheet having excellent fatigue resistance and stretch flangeability, the steel sheet having a chemical composition comprising, by mass %, C: 0.04 to 0.13%, Si: 0.9 to 2.3%, Mn: 0.8 to 1.8%, P: 0.1% or less, S: 0.01% or less, Al: 0.1% or less, N: 0.008% or less, and the remainder being Fe and inevitable impurities and a microstructure including, in terms of area ratio, a ferrite phase of 80% or more, a bainitic ferrite phase of 1.0% or more, a pearlite phase of 1.0 to 10.0%, and a martensite phase of 1.0% or more and less than 5.0%, wherein mean grain size of ferrite is 14 μm or less, mean grain size of martensite is 4 μm or less, mean free path of martensite is 3 μm or more, Vickers hardness of ferrite is 140 or more, and a relationship area ratio of martensite/(area ratio of bainitic ferrite+area ratio of pearlite)≦0.6 is satisfied.

2. The galvanized steel sheet according to claim 1, wherein the chemical composition further comprises, by mass %, at least one of chemical elements selected from the group consisting of Cr: 0.05 to 1.0%, V: 0.005 to 0.5%, Mo: 0.005 to 0.5%, Ni: 0.05 to 1.0%, and Cu: 0.05 to 1.0%.

3. The galvanized steel sheet according to claim 1, wherein the chemical composition further comprises, by mass %, at least one of chemical elements selected from the group consisting of Ti: 0.01 to 0.1%, Nb: 0.01 to 0.1%, and B: 0.0003 to 0.0050%.

4. The galvanized steel sheet according to claim 1, wherein the chemical composition further comprises, by mass %, at least one of chemical elements selected from the group consisting of Ca: 0.001 to 0.005% and REM: 0.001 to 0.005%.

5. The galvanized steel sheet according to claim 1, wherein the chemical composition further comprises, by mass %, at least one of chemical elements selected from the group consisting of Ta: 0.001 to 0.010% and Sn: 0.002 to 0.2%.

6. The galvanized steel sheet according to claim 1, wherein the chemical composition further comprises, by mass %, Sb: 0.002 to 0.2%.

7. A method for manufacturing a high strength galvanized steel sheet having excellent fatigue resistance and stretch flangeability, comprising:
hot rolling and pickling a steel slab having the chemical composition according to claim 1,
optionally cold rolling the resulting steel sheet,
heating the steel sheet up to a temperature in a range of 700° C. or higher at a mean heating rate of 8° C./s or more,
holding the steel sheet in a temperature range of 800 to 900° C. for 15 to 600 seconds, then after cooling the steel sheet,
holding in a temperature range of 450 to 550° C. for 10 to 200 seconds, and galvanizing the steel sheet.

8. The method according to claim 7, further comprising conducting alloying treatment for a galvanized layer in a temperature range of 500 to 600° C. under conditions that satisfy: 0.45≦exp [200/(400−T)]×In(t)≦1.0, where T denotes a mean holding temperature in units of ° C., t denotes a holding time in units of s, exp(X) denotes an exponential of X, and In(X) denotes a natural logarithm of X.

9. The galvanized steel sheet according to claim 2, wherein the chemical composition further comprises, by mass %, at least one of chemical elements selected from the group consisting of Ti: 0.01 to 0.1%, Nb: 0.01 to 0.1%, and B: 0.0003 to 0.0050%.

10. The galvanized steel sheet according to claim 2, wherein the chemical composition further comprises, by mass %, at least one of chemical elements selected from the group consisting of Ca: 0.001 to 0.005% and REM: 0.001 to 0.005%.

11. The galvanized steel sheet according to claim 3, wherein the chemical composition further comprises, by mass %, at least one of chemical elements selected from the group consisting of Ca: 0.001 to 0.005% and REM: 0.001 to 0.005%.

12. The galvanized steel sheet according to claim 2, wherein the chemical composition further comprises, by mass %, at least one of chemical elements selected from the group consisting of Ta: 0.001 to 0.010% and Sn: 0.002 to 0.2%.

13. The galvanized steel sheet according to claim 3, wherein the chemical composition further comprises, by mass %, at least one of chemical elements selected from the group consisting of Ta: 0.001 to 0.010% and Sn: 0.002 to 0.2%.

14. The galvanized steel sheet according to claim 4, wherein the chemical composition further comprises, by mass %, at least one of chemical elements selected from the group consisting of Ta: 0.001 to 0.010% and Sn: 0.002 to 0.2%.

15. The galvanized steel sheet according to claim 2, wherein the chemical composition further comprises, by mass %, Sb: 0.002 to 0.2%.

16. The galvanized steel sheet according to claim 3, wherein the chemical composition further comprises, by mass %, Sb: 0.002 to 0.2%.

17. The galvanized steel sheet according to claim 4, wherein the chemical composition further comprises, by mass %, Sb: 0.002 to 0.2%.

18. The galvanized steel sheet according to claim 5, wherein the chemical composition further comprises, by mass %, Sb: 0.002 to 0.2%.
